(19) United States
(12) Patent Application Publication
(10) Pub. No.: US 2011/0073195 A1
(43) Pub. Date: Mar. 31, 2011

(54) PREHEATING BACKWATER DEVICE

(76) Inventor: Po-Hsiang HSU, Hsinchu City (TW)

(21) Appl. No.: 12/568,068

(22) Filed: Sep. 28, 2009

(51) Int. Cl. F16L 53/00; G05D 23/00; E03B 5/00

(52) U.S. Cl. 137/334; 236/51; 137/565.01

(57) ABSTRACT

A preheating backwater device comprises a tank body fabricated with a pump, a control module, a Y-pipe and a plurality of pipes inside. The device is assembled with a general hot-water heater and existing hot water and water supply pipes in a building. Users can activate the device either by pressing wire-linked buttons or using a wireless remote control. Lower temperature water in the hot water pipes can be pumped out and recirculated to the hot-water heater of the backwater device for a preset amount of time. If the automatic control module fails and preheating is not stopped automatically, an overheat protection device activates to guide the hot water to a cold water pipe via a backwater gate. A pressure control device installed in one end of a three-port connector of the overheat protection device stabilizes the pressure in the pipes. The design can prevent dangerous overheating situations.

### FIELD OF THE INVENTION

The utility model relates to a preheating backwater device. More specifically, the utility model relates to a backwater device assembled with a general hot-water heater and existing hot water pipes and water supply pipes in a building. According to the time (about several tens of seconds to several minutes) set up in a control module for actual demands and the pipe length in a building, users can press wire linked buttons or use wireless remote control first to turn on the preheating backwater device. With the device, water in the hot water pipes can be pumped out and recirculate to the hot-water heater for heating. Recirculation lasts until the time set up in advance. Therefore, users only need to turn the faucet to the hot water mark and hot water will be accessible. Furthermore, an overheat protection device and a backwater gate or pressure control device are installed in the backwater device. If the timing clock is failed, the overheat protection device will guide the hot water in the hot water pipes to a cold water pipe via the backwater gate or keep stability of pressure in the pipes to prevent the dangerous situations, such as explosion, caused by overheat.

### BACKGROUND OF THE INVENTION

When people turn the faucet to use hot water, cold water in the pipe will first flow out, followed by hot water after several minutes. The water that has flowed out before the hot water starts flowing will be wasted.

Based on a family having an average of 3.3 persons, according to the way people traditionally use hot-water heater, 100 liter of water is lost just waiting for the cold water flowing out to turn hot. A family looses 36,500-liters of water every year. According to the applicant's country which has 7.5 million families, a total 68,437,500,000 gallons of water per year are lost. Namely, 187,500,000 gallons of water per day are lost. This exacerbates the greenhouse effect.

Furthermore, according to the announcement from the annual convention of world population held in Tours, France in 2007, the world's population had been over 6.5 billions by June 2005. Based on the traditional way people use hot-water heater, everyone wastes 33.3 liters of cold water by turning on the faucet to wait for hot water every day. If it is calculated based on the global population, a shocking 54,112,500,000 gallons of water are wasted a day.

It is a worldwide trend for every country to focus on economy, disadvantaged minority, power consumption and education. The utility model is invented following this trend, especially in use of energy. It can save the wasted resources and reutilizes them. The utility can help to prosper the economy as well.

Therefore, some manufacturers have developed a fixed time and constant temperature backwater device, comprising a timer, an automatic temperature detector, an uninterruptible power supply, a pressure relief valve and a pressure barrel. Users can set up time to recirculate water via the aforementioned units based on demands. The backwater device will start to heat the backwater according to the set-up time. However, when users are not able to use hot water immediately, the backwater device still operates according to the set-up time so as to cause inconvenience that set-up time doesn't match the real time people use hot water. Hence, gas and electric power are wasted. It can not save gas and electric, and even worse, it may even cause users to worry about the hot-water heater to burn up without warning.

Furthermore, inner diameters of the kind of backwater device are usually smaller with more windings and not compatible with that of the pipes in the building. It is easy to cause insufficient water pressure and low water flow under this situation.

Therefore, due to the aforementioned situations when the backwater device is used, the inventor worked very hard to achieve this utility model.

### SUMMARY OF THE INVENTION

The main object of the utility model is to provide a preheating backwater device. The backwater device comprises a tank body, a pump, a control module, an overheat protection device and a backwater gate as its main components. It is assembled and worked with a general hot-water heater and existing hot water pipes and water supply pipes of a building. Users can remotely control the pump of the preheating backwater device via the control module in advance before the faucet is opened to offer hot water. The water in the hot water pipes is recirculated to the hot-water heater to be heated again and flows back to the hot water pipes via a hot water outlet of a general hot-water heater. Recirculation lasts (about several tens of seconds to several minutes) until a set-up time. It is ready for providing hot water to users.

Another object of the utility model is to provide a preheating backwater device, wherein the overheat protection for the backwater device is active when a timing clock is failed. It guides the hot water in the hot water pipes to a cold water pipe via a backwater gate or is equipped with a pressure control device to keep stability of pressure in the pipes so that explosion due to overheat can be prevented. Therefore, it has the performance of safety protection.

Another object of the utility model is to save water, electricity, gas and time with the device in case of waste of resources. It eases users' uneasiness on continual heating of the hot-water heater or other heating devices, such as an instant electric water heater, a gas heater, an electrical/gas storage hot-water heater or a boiler.

Another object of the utility model is to provide a preheating backwater device. The device gets rid of the pressure barrel, timer, automatic temperature detector, uninterruptible power supply, and pressure relief valve in a traditional backwater device to save cost of the preheating backwater device.

A minor goal of the present utility model is to provide a preheating backwater device. The inner diameter of the backwater device of the utility model is enlarged. The bending portions are straightened. The length is reduced. Therefore, water is able to flow smoothly away and allow quick heating.

### BRIEF DESCRIPTION OF THE DRAWING

FIG. 1 is a sectional view of the preheating backwater device in the present utility model.

FIG. 2 is a plan view of the assembly of the preheating backwater device, a general hot-water heater and the existing hot water pipes and water supply pipes in the prevention utility model.

FIG. 3 is a sectional view of another embodiment of the preheating backwater device in the present utility model.

### DETAILED DESCRIPTION OF THE PREFERRED EMBODIMENTS

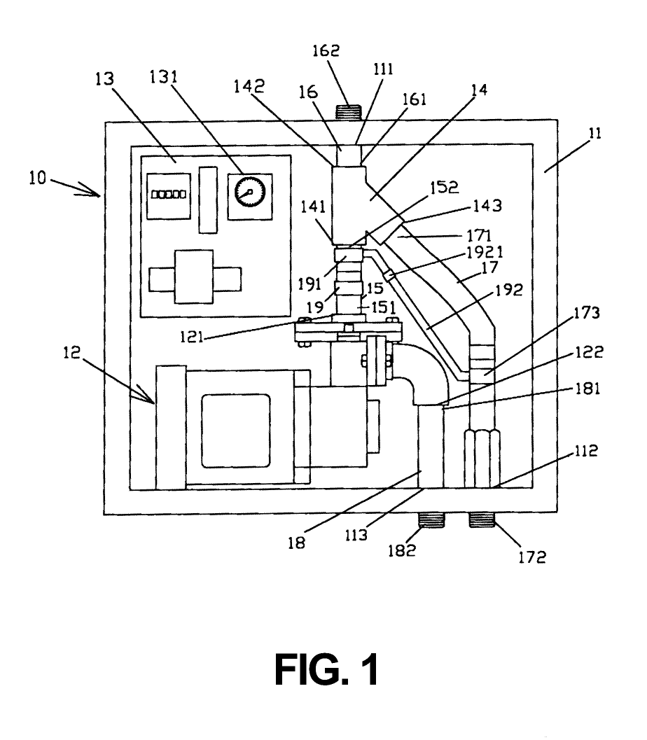

Please refer to FIG. 1. The preheating backwater device (10) of the present utility model is composed of a tank body (11), a pump (12), a control module (13), a Y-pipe (14), a first joint pipe (15), a second joint pipe (16), a third joint pipe (17) and a fourth joint pipe (18). The pump (12) is one-piece molded. The Y-pipe (14) is for maintaining water pressure.

An interface (111) is on a proper place of the inner top surface of the tank body. Two interfaces (112)(113) are on proper places of the inner bottom surface of the tank body (11). The pump (12) is installed on a proper place of the inner bottom surface of the tank body (11) and doesn't block the two interfaces (112)(113). The control module (13) is installed on the inner back surface of the tank body (11) and connected with the pump (12) so that the pump (12) can be controlled to drive. The control module (13) can drive and stop the pump (12). A timing clock (131) is set up thereon.

Connect a nozzle (151) in one end of the first joint pipe (15) with an outlet (121) of the pump (12) for fixing so that the first joint pipe (15) is connected to the outlet (121) of the pump (12). The other nozzle (152) at the other end of the first joint pipe (15) is connected with a first interface (141) of the Y-pipe (14) for fixing.

Connect a nozzle (161) in one end of the second joint pipe (16) with a corresponding second interface (142) of the Y-pipe (14) and fix them. The other nozzle (162) at the other end of the second joint pipe (16) is connected with the corresponding interface (111) of the tank body (11) and fixed.

Connect a nozzle (171) at one end of the third joint pipe (17) with a corresponding third interface (143) of the Y-pipe (14) and fix them. The other nozzle (172) at the other end of the third joint pipe (17) is connected with the corresponding interface (112) of the tank body (11) and fixed.

Connect a nozzle (181) at one end of the fourth joint pipe (18) with a corresponding intake (122) of the pump (12) and fix them. The other nozzle (182) at the other end of the fourth joint pipe (18) is connected with the corresponding interface (113) of the tank body (11) and fixed. Assembly of the preheating backwater device (10) is completed.

Furthermore, in case the timing clock (131) in the control module (13) is out of order so that it won't stop when the time set up for preheating in advance is up, an overheat protection device (19) installed on the first joint pipe (15) in the present utility model will start to guide the hot water from a three-port connector (191) to a cold water pipe via a backwater gate (1921) of a fifth joint pipe (192) and a three-port connector (173) of the third joint pipe (17) to prevent the dangerous situations, such as explosion, caused by overheat.

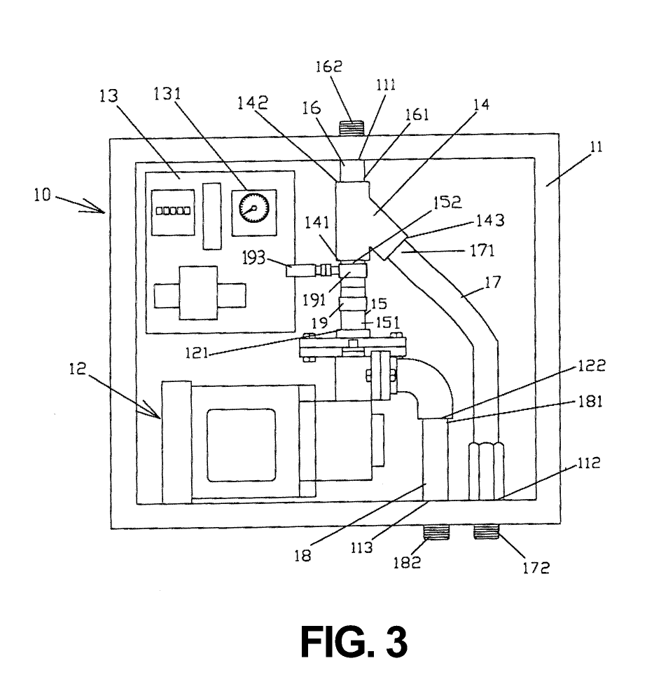

Please refer to FIG. 3. It is a sectional view of another embodiment of the present utility model. The overheat protection device (19) doesn't need to be equipped with the fifth joint pipe (192) and backwater gate (1921). The third joint pipe (17) doesn't need to be equipped the three-port connector (173), either. The device can add a pressure control device (193) at the same end of the three-port connector (191) to connect with the preheating backwater device (10) to keep stability of pressure in the pipes. Thus, it can prevent the dangerous situations, such as explosion, caused by overheat as well.

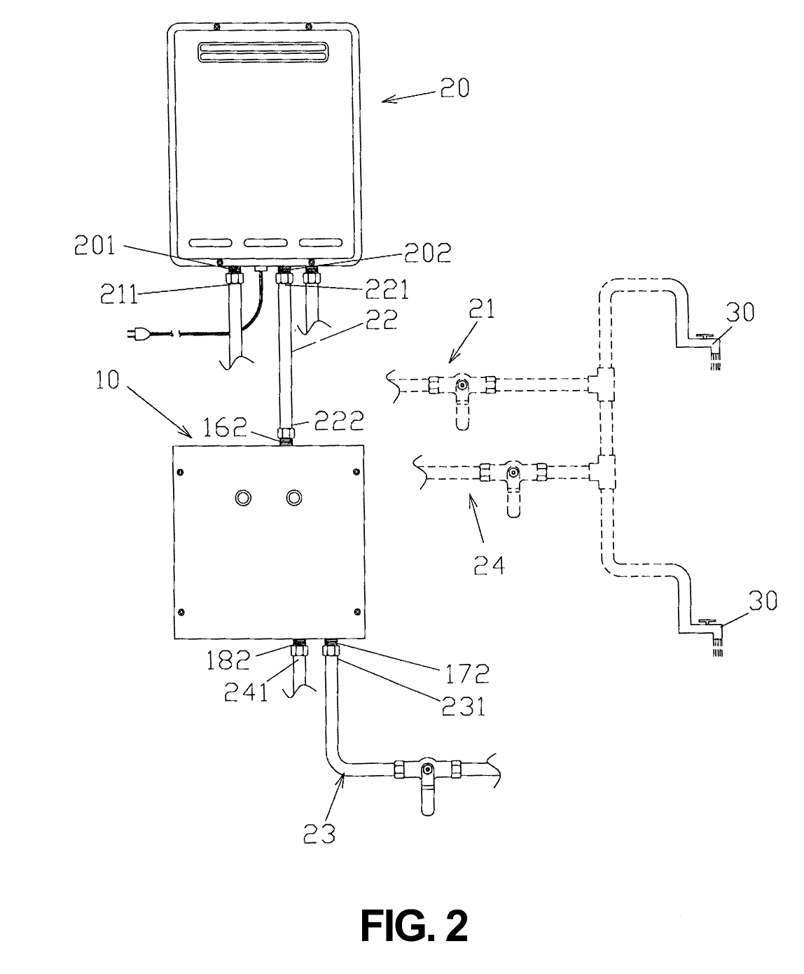

Please refer to FIG. 2. It shows a hot water pipe (21) installed in advance in a general building and a recirculating pipe (24). The preheating backwater device (10) of the present utility model is installed in one end (or below) of a general hot-water heater (20). An intake (211) in one end of the hot water pipe (21) installed in a general building in advance is connected with a hot water outlet (201) of the hot-water heater (20) and gets fixed. Meanwhile, provide another pipe (22). Connect the preheating backwater device (10) with the hot-water heater (20). A nozzle (221) at one end of the pipe (22) is connected with a water supply interface (202) of the hot-water heater (20). A nozzle (222) at the other end of the pipe (22) is connected with the nozzle (162) of the preheating backwater device (10).

An outlet (231) at one end of a water supply pipe (23) installed in a general building in advance is connected with a nozzle (172) of the preheating backwater device (10) and gets fixed. An interface (241) at one end of the recirculating pipe (24) is connected with a nozzle (182) of the preheating backwater device (10) and gets fixed. Furthermore, according to current situation and user's requirement, set up time for the control module (13) of the preheating backwater device (10). Then, the preheating backwater device (10) has been assembled with the general hot-water heater (20), existing hot water pipe (21) and water supply pipe (23).

If users need to use hot water to take a shower, a faucet (30) doesn't need to be turned on before taking off clothes. It is only to press a switch manually installed in advance in a proper location of the building or turn on the switch by remote control to start the pump (12) of the preheating backwater device (10). The pump (12) will pump out the water in the hot water pipe (21) to the hot-water heater (20) for heating via the fourth joint pipe (18), the first joint pipe (15) and the second joint pipe (16). Then the water flows to the hot water pipe (21) from the hot water outlet (201) of the hot-water heater (20). The water keeps recirculating. It lasts until the set-up time is up. Now, users can use hot water immediately by opening the faucet (30).

The preheating backwater device (10) is not limited to use with the hot-water heater (20). It can be used with other heating equipments. For example, an instant electric water heater, a gas heater, an electrical/gas storage hot-water heater or a boiler can have the effect of preheating backwater. The preheating backwater device (10) can be also installed inside the hot-water heater (20) to form a unity.

What is claimed is:

1. A preheating backwater device having a tank body equipped with a pump, a control module, a Y-pipe and at least one pipes inside, wherein the pump is connected with the control module, one pipe is connected with the pump and the Y-pipe, respectively, and the Y-pipe is connected with pipes of the tank body via other pipes to complete assembly of the backwater device.

2. The preheating backwater device according to claim 1, further having a nozzle at one end of the first joint pipe is connected with an outlet of the pump; the other end of the first joint pipe is connected with a first interface of the Y-pipe; a nozzle at one end of the second joint pipe is connected with a second interface of the Y-pipe; the other end of the second joint pipe is connected with an interface of the tank body, a nozzle at one end of the third joint pipe is connected with a third interface of the Y-pipe; the other end of the third joint pipe is connected with an interface of the tank body; a nozzle at one end of the fourth joint pipe is connected with an intake of the pump; a nozzle in the other end of the fourth joint pipe is connected with an interface of the tank body.

3. The preheating backwater device according to claim 1, wherein the control module is connected to a switch installed in a general building so that users can turn on the switch manually or by remote control.

4. The preheating backwater device according to claim 1, wherein the control module is equipped with a timing clock.

5. The preheating backwater device according to claim 1, wherein the preheating backwater device can be installed inside the hot-water heater to form a unity.

6. The preheating backwater device according to claim 2, wherein an overheat protection device is mounted on the first joint pipe, the first joint pipe is connected with the Y-pipe via a three-port connector, and the three-port connector is connected to a three-port connector of the third joint pipe via a fifth joint pipe.

7. The preheating backwater device according to claim 6, wherein the fifth joint pipe is equipped with a backwater gate

8. The preheating backwater device according to claim 6, wherein a pressure control device is installed on one end of the three-port connector of the overheat protection device to connect with the preheating backwater device.
